(19) United States
(12) Patent Application Publication
(10) Pub. No.: US 2012/0224828 A1
(43) Pub. Date: Sep. 6, 2012

(54) CONTENT SELECTION

(76) Inventors: Stephen Silber, Redmond, WA (US); Craig Hubbell, Seattle, WA (US)

(21) Appl. No.: 13/363,731

(22) Filed: Feb. 1, 2012

Related U.S. Application Data
(60) Provisional application No. 61/440,566, filed on Feb. 8, 2011.

(51) Int. Cl. H04N 5/775; H04N 9/80

(52) U.S. Cl. 386/230; 386/248; 386/E05.07; 386/E09.011

(57) ABSTRACT

A method of providing an audio visual output stream includes the initial steps of maintaining a database of video media clips and a database of associated tags. The next steps include receiving information identifying at least one audio track and selecting video media associated with the at least one audio track. Then, if no video media associated with the audio track is available in the database of video media clips, a selection algorithm for the selection of video media is applied.

### CROSS REFERENCE TO RELATED APPLICATIONS

This application claims the benefit of U.S. provisional patent application Ser. No. 61/440,566 filed Feb. 8, 2011, which is hereby incorporated by reference.

### BACKGROUND OF THE INVENTION

The invention relates to methods and systems for selecting audio and/or video media content, and more particularly, but not exclusively, to methods of selecting content for playback by a media player.

It is common to provide media content as background or displays in commercial settings, for example background music is often played in stores and shopping malls. It is known that playing certain types of media content may influence people for example leading to increasing sales of products associated with the media being played, or simply advertising a certain music track that has been recently released.

Currently, playlists for playing media content may be generated either by manually selecting each item of media content in a specific order in which it is desired that the tracks be played back, or by allowing a number of media items to be played in a random, or shuffle, order.

Manual selection of media items allows a playlist to be tailored to target a certain desired effect. Furthermore, announcements or messages may be manually scheduled within the playlist to play advertisements or other information as part of the media presentation. However, such an approach is expensive as it requires a person to spend time selecting each track and announcement that is to be played. Often, once generated, such manually created playlists may be reused over an extended period of time, during which the same media items will be played in the same order repeatedly.

Furthermore, in order to change any messages that may be broadcast as part of a campaign, it is necessary to re-generate the playlist, further increasing the cost associated with this approach.

In contrast, playing media items in a random order provides a relatively cheap way of generating a playlist by selecting a group of media items and allowing playback in a randomly determined order. However, this approach provides no control over the order in which items playback, and may lead to occasions in which items are repeated within a short timeframe. Furthermore, it is not possible using this approach to tailor the playlist to have a desired effect.

Furthermore, current systems do not provide any way of matching different types of media to generate a multimedia presentation. In particular, current techniques are not able to match a video presentation to a selected audio presentation in a playlist without manual intervention.

Embodiments of the present invention aim to address at least some of the above described drawbacks in the prior art.

According to an aspect of the invention, there is provided a method of providing an audio visual output stream, the method comprising maintaining a database of video media clips, maintaining a database of tags associated with the video media clips, receiving information identifying at least one audio track to be output to the audio visual output stream, selecting video media associated with the at least one audio track if video media associated with the audio track is available in the database of video media clips, and if no video media associated with the audio track is available in the database of video media clips, applying a selection algorithm for the selection of video media.

Selecting video media associated with the audio track may comprise determining if a music video specifically associated with the audio track is available in the database of video media, and if so selecting the associated music video and providing audio from the video media clip in place of the audio track.

Applying a selection algorithm may comprise selecting a video media clip in dependence on the database of tags associated with the video media clips, and muting audio from the video media clip.

Applying the selection algorithm may further comprise identifying an album associated with the audio track, and selecting video media associated with the album based on the database of tags associated with the video clips. Alternatively or additionally, applying a selection algorithm may further comprise identifying an artist associated with the audio track, and selecting video media associated with the artist based on the database of tags associated with the video clips, and/or selecting video media not associated with any audio track based on the database of tags associated with the video clips.

According to embodiments, the method may further comprise displaying the selected video media, and rendering the audio track, or displaying the selected video media, and rendering audio data associated with the selected video media and not the audio track.

Receiving information identifying at least one audio track to be played may comprise receiving information identifying a current audio track and a subsequent audio track to be played, wherein applying a selection algorithm for the selection of video media may further comprise selecting video media based on the identity of the current track and the identity of the subsequent track.

Maintaining the database of tags associated with the video media clips may further comprise maintaining a database of global tags associated with the video media clips and a database of customer specific tags associated with the video media clips. Both the global tags and the customer specific tags may be associated with a video media clip, and the customer specific tags may be used in preference to the global tags.

The database of tags may comprise a video override flag associated with a video media clip, and the selected video media clip may be output to the audio visual stream synchronized with the at least one audio track when the video override flag is set. A video media clip having a length different to the at least one audio track may be selected to de-synchronize the playback of video media clips and the at least one audio track output to the audio visual stream.

According to a further aspect of the invention, there is provided a method of providing an audio visual output stream comprising receiving information identifying at least one audio track to be played, selecting video media from a first category, the first category having a first relationship with the audio track, wherein if no video media is available in the first category, selecting video media from a second category, the second category having a second relationship with the audio track.

If no video media is available in the first or second category, video media may be selected from a default category, the default category having no relationship with the audio track.

According to a further aspect of the invention, there is provided an apparatus for selecting an imagery item, the apparatus comprising a first store configured to store a database of video media clips, a second store configured to store a database of tags associated with the video media clips, and a control unit configured to receive information identifying at least one audio track to be played and to select video media associated with the at least one audio track if video media associated with the at least one audio track is available in the database of video media clips, and wherein the controller is further configured to apply a selection algorithm for selecting video media if no video media associated with the at least one audio track is available in the database of video media clips.

According to a further aspect of the invention, there is provided a method of providing an audio visual output stream, the method comprising maintaining a database of video media clips, maintaining a database of tags associated with the video media clips, receiving information identifying at least one audio track to be played, determining if a music video specifically associated with the audio track is available in the database of video media, and if so selecting the associated music video and providing audio from the video media clip in place of the audio track, and if no music video specifically associated with the audio track is available in the database of video media clips, applying a selection algorithm for the selection of video media, wherein applying the selection algorithm comprises the steps of identifying an album associated with the audio track, and selecting video media associated with the album based on the database of tags associated with the video clips, wherein if no video media associated with the album is available, performing the steps of identifying an artist associated with the audio track, and selecting video media associated with the artist based on the database of tags associated with the video clips, wherein if no video media associated with the artist is available, selecting video media not associated with any audio track based on the database of tags associated with the video clips.

According to a further aspect of the invention, there is provided a method of providing an audio output channel, the method comprising maintaining a database of audio tracks, maintaining a database of track rules associated with the audio tracks, maintaining a database of channel parameters relating to a desired mix of audio to be output on the audio output channel, and executing a heuristic algorithm to select an audio track to be output on the audio output channel based on an evaluation of the channel parameters and the track rules.

The method may further comprise maintaining a database of audio announcements, maintaining a database of announcement rules associated with the audio announcements, and wherein executing the heuristic algorithm further comprise automatically inserting an audio announcement into the audio output channel based on an evaluation of the channel parameters and the announcement rules.

The track rules associated with the audio tracks may comprise one or more of content expiration time, channel affinity, day of week, random playback flag, pod grouping, time of day, time separation, song separation, title separation, and artist separation and track separation.

The announcement rules associated with the audio announcements may comprise one or more of campaign expiration, days of week, random playback flag, grouping of messages, time of day, time separation, and song separation.

According to a further aspect of the invention, there is provided an apparatus comprising at least one memory, the at least one memory configured to store a database of video media clips and a database of tags associated with the video media clips, and a processor, the at least one memory further comprising logic instructions that when executed on the processor cause the apparatus to receive information identifying at least one audio track to be output to an audio visual output stream, select video media associated with the at least one audio track if video media associated with the audio track is available in the database of video media clips, and if no video media associated with the audio track is available in the database of video media clips, apply a selection algorithm for the selection of video media.

Exemplary embodiments of the invention will now be described, by way of example, with reference to the accompanying drawings.

### BRIEF SUMMARY

A method of providing an audio visual output stream includes the initial steps of maintaining a database of video media clips and a database of associated tags. The next steps include receiving information identifying at least one audio track and selecting video media associated with the at least one audio track. Then, if no video media associated with the audio track is available in the database of video media clips, a selection algorithm for the selection of video media is applied.

One object of the present disclosure is to describe an improved system for selecting a piece of audio content.

### BRIEF DESCRIPTION OF THE SEVERAL VIEWS OF THE DRAWINGS

FIG. 1 illustrates a system for selecting a piece of audio content.

FIG. 2 illustrates a system for selecting an imagery asset to match a selected audio track.

FIG. 3 illustrates a method of selecting imagery assets.

FIG. 4 illustrates a timeline of selected audio and imagery assets.

### DETAILED DESCRIPTION

For the purposes of promoting an understanding of the disclosure, reference will now be made to the embodiments illustrated in the drawings and specific language will be used to describe the same. It will nevertheless be understood that no limitation of the scope of the disclosure is thereby intended, such alterations and further modifications in the illustrated device and its use, and such further applications of the principles of the disclosure as illustrated therein being contemplated as would normally occur to one skilled in the art to which the disclosure relates.

Embodiments provide methods and systems for creating one or more playlists of content from a range of available stored audio content. Each playlists includes rules relating to playback of the individual audio tracks assigned to the playlist to allow a next audio item to be played to be determined automatically based on the rules. By controlling the rules assigned to the audio items in the playlist, a desired effect, or mix of music can be achieved without requiring manual generation of the play order.

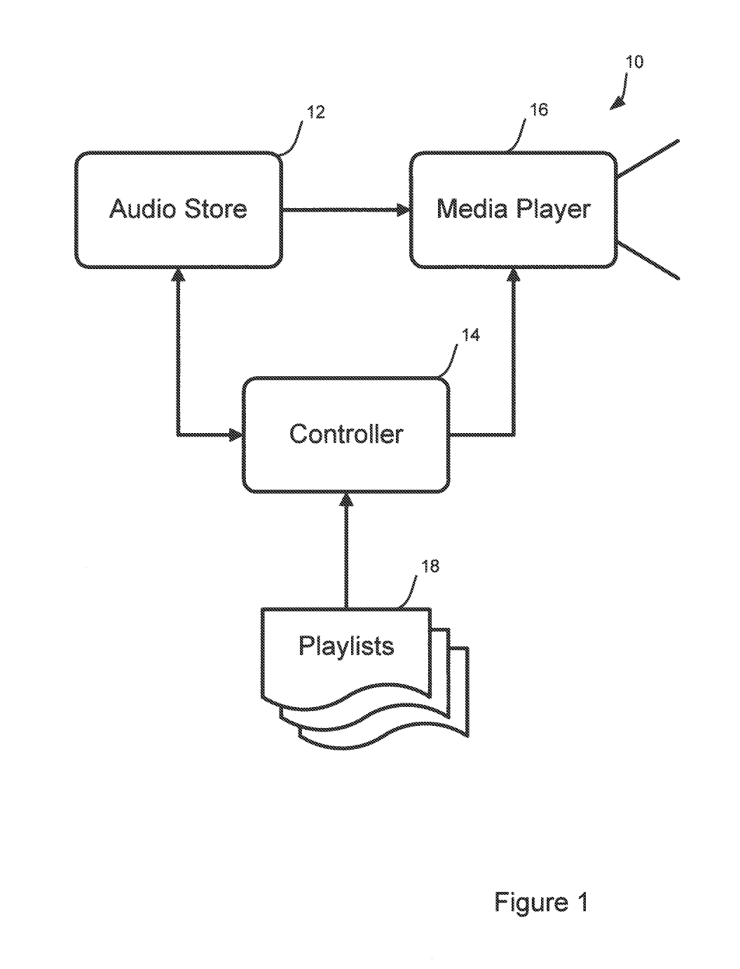

FIG. 1 illustrates a system 10 suitable for implementing some embodiments of the invention. An audio store 12 stores a number of programs comprising individual audio tracks, such as music tracks or announcements. A controller 14 is coupled to the audio store 12, and is operable to select programs stored in the audio store according to rules provided in one or more playlists 18. The selected audio tracks can then be passed to the media player 16 for playback on one or more channels.

The content items are selected based on a set of heuristics that operate on prebuilt ‘buckets’ of content. Each playlist provides information defining which content items are contained within a ‘bucket’ of content. A heuristic algorithm executed on the controller 14, uses one or more rules defined within the playlist to select a piece of content contained within the ‘bucket’ to play next on the media player.

In some embodiments, the heuristic algorithm may be used to generate an ‘ordered playlist’ covering a certain period of time and then this ‘ordered playlist’ can be used to control the media player until a new ordered playlist is required.

The selection of audio tracks is based on one or more selection rules. In some embodiments, two groups of selection rules are implemented, a first group related to the selection of music content from the predefined ‘buckets’, and a second group of rules pertaining to the selection of in-store advertisements from messaging campaigns.

Selection rules may be tailored as required by an end user to ensure the desired mix of audio/messaging is obtained, and to match any local requirements, by specifying associated parameters. The selection rules may be prioritised, such that higher priority rules are considered first and always adhered to, while lower priority rules may not always be implemented. For example, each selection rule may have an associated weighting factor relating to the priority or precedence of that rule, the heuristic algorithm taking into account the relative weights of the defined rules.

Example rules for the selection of music tracks may include one or more of:
1. Content Expiration: No track will be played if it is expired. Most often used to control the playback of pre-release material.
2. Channel Affinity: Enforce that we are using the current channel's playlist.
3. Days of the Week: Assign different playlists or programs to specific days of the week.
4. Random or Sequential Playback: Control whether a program is being played in random order (typical) or sequential (for playback of a specific album, for example).
5. Absolute Pod: Group playback of tracks into pods (groups) of a specific size. Fail if we cannot.
6. Dayparts: Assign different playlists or programs to specific times of the day.
7. Time Separation: Play something from a specific program every n minutes.
8. Desired Pod: Try to group playback of tracks into pods of a specific size. Do not fail if we cannot achieve the desired pod size.
9. Program Song Separation: Play something from a specific program every n songs.
10. Title Separation: Don't play songs with the same title too frequently. (Example: don't play different covers of “White Christmas” back to back.)
11. Artist Separation: Don't play songs by the same artist too frequently.
12. Track Separation: Don't play the same track too frequently.

According to some embodiments, the rules may be statically defined, but parameters of the rules may be adjustable to obtain a desired music mix. For example, if a customer wanted to hear more music by a particular artist, a parameter associated with rule 11, Artist Separation, to 10 minutes so that music by that artist may then be selected as frequently as every 10 minutes. Generally, a default set of parameters may be provided that, for example, would specify an artist separation of 45 minutes, leading to relatively more music by the selected artist being selected.

In-store messages, or advertisements, are organized into one or more ‘campaigns’. Each campaign is a collection of individual recorded audio tracks that are provided by a user of the system. The heuristic algorithm selects messages from one or more campaigns at certain frequencies, defined by the playlist rules, within the audio playback. As discussed above, the selection of in-store messages may be based on a different set of rules and criteria than for the selection of music tracks.

Example rules for the selection of announcements may include one or more of:
1. Campaign Expiration: No message will be played from this campaign if the campaign is expired.
2. Days of the Week: Assign different campaigns to different days of the week.
3. Random or Sequential Playback: Control whether messages are drawn randomly from the campaign or played in sequence. If random, implicitly enforce message track separation of 1 (that is, prevent back-to-back playback of the same message). Note that this takes the place of Track Separation from Music Rules.
4. Podding: Group playback of messages into pods of a specific size.
5. Dayparts: Assign different campaigns to specific times of the day.
6. Time Separation: Play something from the selected campaign every n minutes. Mutually exclusive with Song Separation.
7. Song Separation: Play something from the selected campaign every n songs. Mutually exclusive with Time Separation.

The predefined ‘buckets’ or campaigns of audio content can be constructed based on the desired stylistic parameters to meet an end user's requirements. Parameters are then assigned to the rules in order to control the music mix selected by the heuristic algorithm. For example, parameters may be set to provide a mix of 25% light jazz and 75 classic rock (or any other genre or mix of music tracks), with in-store messaging being layered in every 20 minutes on certain days.

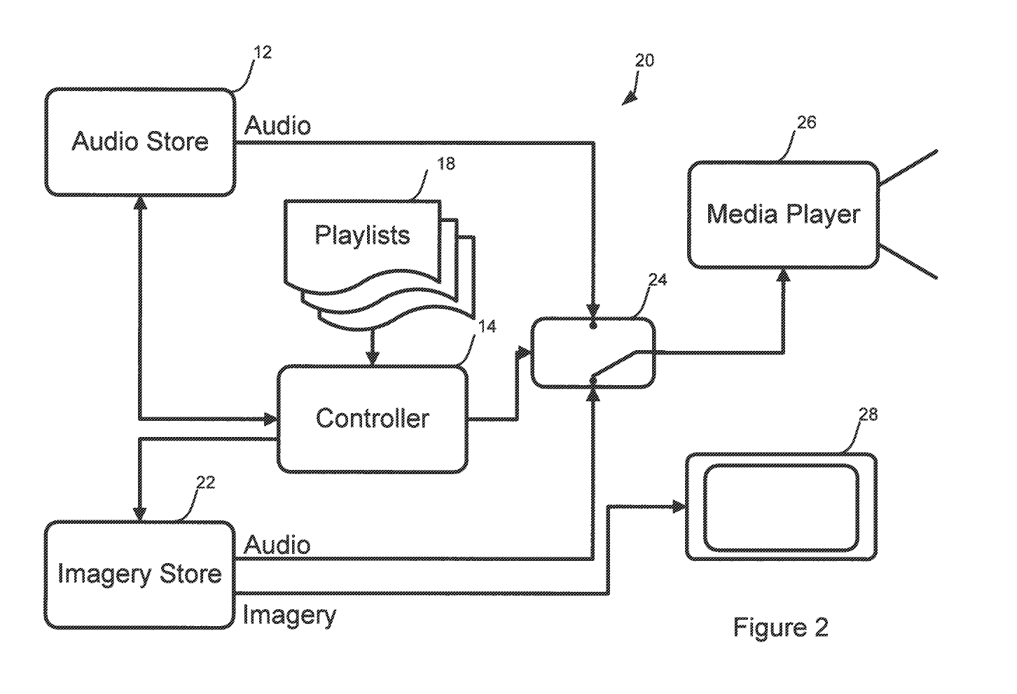

According to some embodiments, imagery can be selected for playback in conjunction with an audio track to provide a complete multimedia presentation. FIG. 2 illustrates a system that can be used to implement some embodiments in which video or other imagery is provided.

The system illustrated in FIG. 2 comprises the audio store 12, controller 14, and playlists 18 of FIG. 1, and further comprises an video media store 22, an audio switch module 24, display 28, and audio output 26.

The video media store 22 comprises a store of video and slideshow assets, collectively referred to as video media clips, that can be selected to provide an imagery accompaniment for an audio track being played. Controller 14 executes a video media selection method based on the selected audio track and instructs the video media store 22 to provide a selected imagery asset to the display 28. Audio switch module 24 receives audio output from both the audio store and the video media store, and allows selection of an audio signal under control of the controller 14. The audio signal selected in the audio switch module 24 is then provided to audio output 26.

Imagery is selected in dependence on audio content being (or about to be) played. Thus, the selected audio drives the selected video media content. Selection of audio tracks may be achieved using the method described above, or alternatively, any method of providing a selected audio may be used, such as a predefined ordered playlist, and video media clips can then be selected to match an audio presentation selected for output.

All imagery content is stored in the video media store, which may be provided independent from the store of audio content. Video content may be classified into four types:
1. Music videos: These are played in lieu of the selected audio track, and take over the audio channel with the soundtrack of the video.
2. Mute videos: These are played on-screen while the selected song is played.
3. Image slideshows: These are played on-screen while the selected song is played.
4. Asset groups: These are collections of mute videos or slideshows that are played in sequence. They can be thought of as pre-defined pods of content. Note that asset groups may have a maximum time duration that is considerably shorter than the sum of the child assets' lengths.

Mute videos, image slideshows, and asset groups are considered to be ‘mute assets’, that is mute videos and slideshows do not have any associated audio content. In contrast, music videos relate to a specific music track and include the audio of the music track.

According to some embodiments of the invention, two groups of audio and video content may be stored in the audio and video stores, relating to a global collection of audio and video assets and a customer specific selection. The customer specific selection may be configured to override associations of audio and video content provided in the global selection. This allows a customer to customize associations between audio and video assets to provide a desired output, allowing videos relating to specific customer content to be selected in preference to more generic content provided in the global collection of media.

The global collection and customer specific selection may comprise separate stores of content, or may share content and be provided as a separate database of tags associated with the stored content.

Alternatively, the customer specific selection may be compiled with the global collection of audio and video content to provide a single customized collection of content according to the needs of the customer. Such an approach may simplify the management of content at a player device, thereby allowing the playback content and rules to be easily customized for a specific customer while avoiding unnecessary complication of the player device.

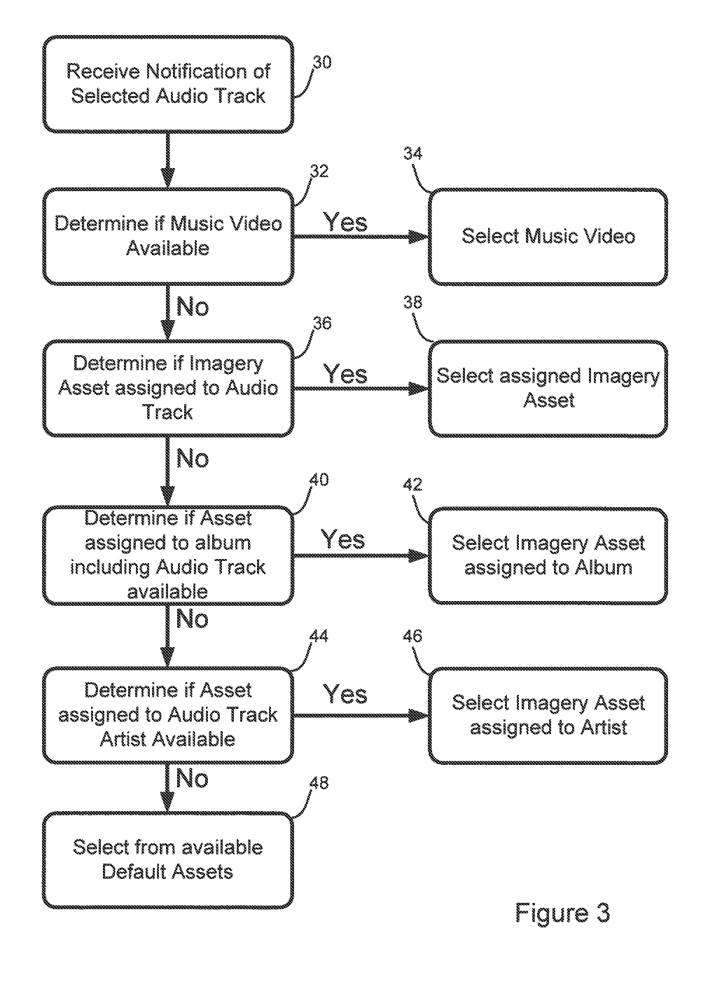

FIG. 3 illustrates a method of selecting video media according to some embodiments. The method illustrates a series of steps performed in selecting suitable imagery. The method terminates as soon as an appropriate video media clip is found.

In the method of FIG. 3 a notification of a selected audio track is received in block 30. A determination is then made in block 32 as to whether a music video associated with the selected audio track is available in the imagery store. If an associated music video is available, the method proceeds to block 34 in which the associated music video is selected for playback.

If it is determined that no associated music video is available, a determination is made in block 36 as to whether a specific mute video has been assigned to the selected audio track. If so, the method proceeds to block 38 and the assigned mute video clip is selected for playback. If no mute video clip has been assigned to the selected audio, a determination is then made in block 40 if any video media clips are available that have been assigned to an album including the selected audio track. If so, a video media clip assigned to the related album is selected for playback in block 42. If not, a determination is made in block 44 as to whether any video media clips are available that have been assigned to the artist of the selected audio track. If so, the artist related video media clip is selected for playback. If no artist related video media clips for the selected audio track are available, a media clip may be selected from a default asset group.

In some embodiments, a newly selected video asset may ‘override’ a currently playing video, such that the currently playing video media clip is halted before the end of the currently playing video media clip is reached, and playback of the newly selected video asset is then commenced. A Video Override flag may be associated with video assets, and if set the selected video overrides any currently playing video.

The method of selecting an imagery asset may be broken down into the following steps:
1. Examine the currently playing song, or select one if no song is currently playing.
2. Look in the imagery store for a music video assigned to that song. If present, play the music video in lieu of anything else, including the audio track from the selected song.
3. Look in the imagery store for a mute asset assigned to that song. If the mute asset has a Video Override Flag set, or if there is no currently playing mute asset, play the it on-screen.
4. Look in the imagery store for a mute asset assigned to the song's album. If the mute asset has a Video Override Flag set, or if there is no currently playing mute asset, play the it on-screen.
5. Look in the imagery store for a mute asset assigned to the song's artist. If the mute asset has a Video Override Flag set, or if there is no currently playing mute asset, play the it on-screen.
6. If no other mute asset has been found, select an asset from the default bucket, which contains assets that are not associated with any particular track, album, or artist. If the mute asset has a Video Override Flag set, or if there is no currently playing mute asset, play the it on-screen.
   a. All assets in the default bucket have an associated weight. The controller 14 will select an asset randomly, according the summed distribution of weights of the available assets.
   b. All assets also have an associated time separation. The controller 14 will select an asset randomly, making sure that an asset is not played again within the time specified by its time separation.

This algorithm is invoked whenever a new audio track is selected or when the currently playing video media clip terminates (e.g. at the end of a mute video or slideshow).

In the case where a music video assigned to the selected song is identified, the audio switch module 24 is controlled to select the audio output from the video media store 22, and the output from the audio store 12 is not used. This ensures lip-sync between the video asset and the audio track is maintained during playback. In the other cases, the audio track output by the audio store 12 is selected by the audio switch module 24, and any audio associated with the video media clip is ignored.

Certain types of assets may have the Video Override flag set by default, for example music videos associated with a specific music track. If the music track is chosen as the next audio output, the associated music video, having the Video Override flag set, will override any currently playing video asset to ensure the music video and music track are played together. Transition effects may be used to switch between the currently playing video asset and the overriding video asset.

Embodiments of the invention may be arranged to deliberately de-synchronize a chosen video media presentation from a playing audio track, except for video media that is explicitly associated with an audio track. For example, when a mute video asset is selected to be played alongside an unrelated audio track the system may attempt to avoid the selected video asset starting at the same time as the audio track. This may be achieved by deliberately selecting video assets that have a different length to the audio track to force the playback of video and audio out of synchronization.

De-synchronization of the video and audio assets may be overridden by the presence of a Video Override flag on a selected video asset, which signals that the video asset should be played synchronized with the audio track, for example in the case of a music video being played alongside the associated music track.

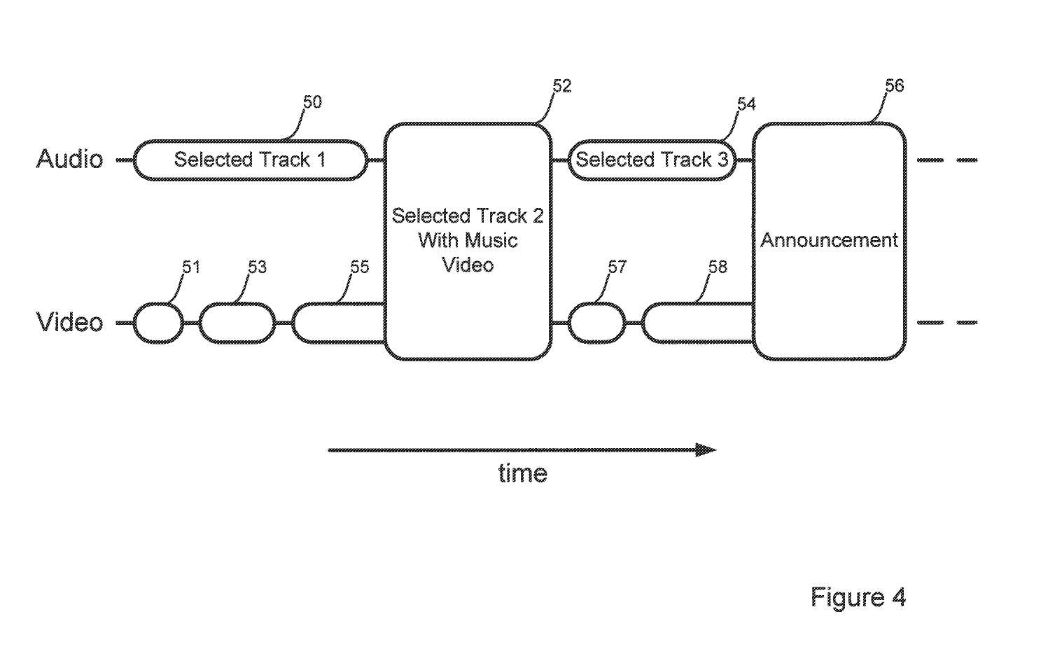

FIG. 4 illustrates a timeline for the playback of audio tracks and video media clips selected using a method as described above. First selected track 50 may be selected for playback on a channel according to the audio track selection method outlined above. As no music video is associated with the first selected track, video media clips 51, 53, 55 are selected from the video media store 22. These imagery items may be videos or slideshows relating to an album or artist associated with the first selected track, or may be chosen from a default selection of video media clips. The length of the video media clips 51, 53, 55 may be deliberately chosen to be different to the length of the audio track 50, such that were possible start times for imagery items and audio tracks are desynchronized.

Following the first selected track 50, a second selected track 52 is chosen. In this case, it is determined that a music video relating to the second selected track is available, and the music video provides the video and audio output. As the music video relates directly to the music track, the Video Override flag will be set for this asset, and therefore the currently playing video media clip 55 will be halted, and video playback switched to the music video 52, which is synchronized with the audio playback. A further selected track 54 is then chosen, with video media clips 57 and 58 chosen as for the first selected track 50. An announcement 56 may then be inserted into the audio video output stream. In this case, it is determined that a video media clip associated with the announcement is available, and that the Video Override flag for this video asset is set, and therefore announcement and associated imagery are played immediately, overriding the currently playing imagery asset 58.

Embodiments of the invention provide a mechanism for dynamically generating a playlist according to one or more rules such that a desired mix of audio and/or video assets is selected for playback. The mechanism is able to dynamically select assets from a range of assets stored on a player device. This means that the relationship between the stored assets and the playlist may be decoupled as compared to prior art systems using static playlists.

For a player device using a static playlist, the content items specified in the static playlist must be provided together with the playlist. Missing content items not stored on the player device may cause errors to be generated as the specified content item is not available. Furthermore, any updates to the content items stored on the player device will have no effect until a corresponding playlist update is provided specifying when those content items should be played.

In contrast, embodiments of the invention allow new assets to be selected for playback without requiring any playlist update. As the playlist is generated dynamically, the heuristic algorithm described above may select newly updated content items that match the desired mix of music/video to be played without requiring any updates to be made to the rules used to select the playlist. Thus, updating a player device may be simplified as only the new content items along with the associated tags need to be uploaded to the device. The player device will then be able to select from the new content items to generate the desired music mix.

The decoupling of the playlist from the available content items provides further flexibility in that the same new content items may be provided to different player devices programmed to provide different music mixes. The two player devices each select items from the newly available assets to according to the desired output, resulting in playlists comprising different mixes of music from the same updated items. This allows common updates to be provided to different devices.

In contrast, systems using statically defined playlists would require different playlists to be crafted by hand and then provided to the different players along with the different associated content items, greatly increasing the effort and cost associated with updating the player device.

Alternatively or additionally, an update may be provided to the player device to change rule parameters and thereby provide a different music mix from the available assets stored on a player device.

A detailed embodiment has been described above. As those skilled in the art will appreciate, a number of modifications and alternatives can be made to the above embodiment whilst still benefiting from the inventions embodied therein.

According to some embodiments, the described selection algorithm may select a video media clip based on both a current track and a subsequent track. In particular, except in the case where a music video related to a selected audio track is available, it is unlikely that a selected video media clip will have exactly the same length as a current audio track.

For a video media clip that is shorter than the remaining play time for the current audio track, a further video media clip will be selected to be displayed alongside the remainder of the current audio track.

In contrast, if the remaining play time for the current audio track is relatively short, it is likely that any selected video media clip will extend beyond the end of the audio track and will continue playing during a next audio track. In this case, the video media selection algorithm may take into account the identity of both the current audio track and the next audio track in order to choose a video media clip that best matches both audio tracks.

According to some embodiments, player devices maybe configured to require an update at regular intervals. If no update is provided after a predetermined period of time, the player device may be configured to use a modified set of parameters to change the mix of assets selected for playback, for example removing advanced features of the heuristic selection method. Alternatively or additionally, the player device may limit the available media assets to a small subset of stored assets, or may delete some or all of the media assets stored on the player device.

Further alternative embodiments include:
Social media integration: information related to social media sites, for example Facebook, such as statistics on how many people have “Liked” or “Friended” a featured artist or the customer could be integrated with imagery assets
Loyalty program integration: if a shopper has opted-in to our customer's loyalty program, the system may react to mobile phone “check-ins” (eg. through FourSquare) and select a song for playback by the shopper's favourite artist
Featured artist promotion: a given artist's music may be dynamically weighted higher than others based on some external influence, such as the customer selecting a new featured artist on a daily or weekly basis to tie in with sales promotions
Shopper selection of music: a given artist's music or a particular song may be dynamically weighted based on (for example) shoppers voting through mobile phones or social web sites

Various other modifications will be apparent to those skilled in the art and will not be described in further detail here.

While the preferred embodiment of the invention has been illustrated and described in the drawings and foregoing description, the same is to be considered as illustrative and not restrictive in character, it being understood that all changes and modifications that come within the spirit of the invention are desired to be protected.

1. A method of providing an audio visual output stream, the method comprising:
maintaining a database of video media clips;
maintaining a database of tags associated with the video media clips;
receiving information identifying at least one audio track to be output to the audio visual output stream;
selecting video media associated with the at least one audio track if video media associated with the audio track is available in the database of video media clips; and
if no video media associated with the audio track is available in the database of video media clips, applying a selection algorithm for the selection of video media.

2. The method of claim 1, wherein selecting video media associated with the audio track comprises determining if a music video specifically associated with the audio track is available in the database of video media, and if so selecting the associated music video and providing audio from the video media clip in place of the audio track.

3. The method of claim 1, applying a selection algorithm comprises selecting a video media clip in dependence on the database of tags associated with the video media clips, and muting audio from the video media clip.

4. The method of claim 3, wherein applying a selection algorithm further comprises:
identifying an album associated with the audio track; and
selecting video media associated with the album based on the database of tags associated with the video clips.

5. The method of claim 3, wherein applying a selection algorithm further comprises:
identifying an artist associated with the audio track; and
selecting video media associated with the artist based on the database of tags associated with the video clips.

6. The method of claim 3, wherein applying a selection algorithm further comprises:
selecting video media not associated with any audio track based on the database of tags associated with the video clips.

7. The method of claim 3, further comprising:
displaying the selected video media; and
rendering the audio track.

8. The method of claim 1, further comprising:
displaying the selected video media; and
rendering audio data associated with the selected video media and not the audio track.

9. The method of claim 1, wherein receiving information identifying at least one audio track to be played comprises receiving information identifying a current audio track and a subsequent audio track to be played; and
wherein applying a selection algorithm for the selection of video media further comprises selecting video media based on the identity of the current track and the identity of the subsequent track.

10. The method of claim 1, wherein maintaining the database of tags associated with the video media clips further comprises maintaining a database of global tags associated with the video media clips and a database of customer specific tags associated with the video media clips.

11. The method of claim 10, wherein when both global tags and customer specific tags are associated with a video media clip, the customer specific tags are used in preference to the global tags.

12. The method of claim 1, wherein the database of tags comprises a video override flag associated with a video media clip, the method further comprising:
outputting to the audio visual output stream the selected video media clip synchronized with the at least one audio track when the video override flag is set.

13. The method of claim 12 further comprising selecting a video media clip that has a different length to the at least one audio track to de-synchronize video media clips and the at least one audio track output to the audio visual output stream.

14. A method of providing an audio visual output stream comprising:
receiving information identifying at least one audio track to be played;
selecting video media from a first category, the first category having a first relationship with the audio track;
wherein if no video media is available in the first category, selecting video media from a second category, the second category having a second relationship with the audio track.

15. The method of claim 14, wherein if no video media is available in the first or second category, selecting video media from a default category, the default category having no relationship with the audio track.

16. An apparatus for selecting an imagery item, the apparatus comprising:
a first store configured to store a database of video media clips;
a second store configured to store a database of tags associated with the video media clips; and
a control unit configured to receive information identifying at least one audio track to be played and to select video media associated with the at least one audio track if video media associated with the at least one audio track is available in the database of video media clips; and
wherein the controller is further configured to apply a selection algorithm for selecting video media if no video media associated with the at least one audio track is available in the database of video media clips.

17. A method of providing an audio visual output stream, the method comprising: maintaining a database of video media clips;
maintaining a database of tags associated with the video media clips;
receiving information identifying at least one audio track to be played;
determining if a music video specifically associated with the audio track is available in the database of video media, and if so selecting the associated music video and providing audio from the video media clip in place of the audio track; and
if no music video specifically associated with the audio track is available in the database of video media clips, applying a selection algorithm for the selection of video media, wherein applying the selection algorithm comprises the steps of:
identifying an album associated with the audio track, and selecting video media associated with the album based on the database of tags associated with the video clips;
wherein if no video media associated with the album is available, performing the steps of identifying an artist associated with the audio track, and selecting video media associated with the artist based on the database of tags associated with the video clips;
wherein if no video media associated with the artist is available, selecting video media not associated with any audio track based on the database of tags associated with the video clips.

18. A method of providing an audio output channel, the method comprising:
maintaining a database of audio tracks;
maintaining a database of track rules associated with the audio tracks;
maintaining a database of channel parameters relating to a desired mix of audio to be output on the audio output channel; and
executing a heuristic algorithm to select an audio track to be output on the audio output channel based on an evaluation of the channel parameters and the track rules.

19. The method of claim 18, further comprising:
maintaining a database of audio announcements;
maintaining a database of announcement rules associated with the audio announcements; and
wherein executing the heuristic algorithm further comprise automatically inserting an audio announcement into the audio output channel based on an evaluation of the channel parameters and the announcement rules.

20. The method of claim 18, wherein the track rules associated with the audio tracks comprise one or more of content expiration time, channel affinity, day of week, random playback flag, pod grouping, time of day, time separation, song separation, title separation, and artist separation and track separation.

21. The method of claim 19, wherein the announcement rules associated with the audio announcements comprise one or more of campaign expiration, days of week, random playback flag, grouping of messages, time of day, time separation, and song separation.

22. An apparatus comprising:
at least one memory, the at least one memory configured to store a database of video media clips and a database of tags associated with the video media clips; and
a processor;
the at least one memory further comprising logic instructions that when executed on the processor cause the apparatus to:
receive information identifying at least one audio track to be output to an audio visual output stream;
select video media associated with the at least one audio track if video media associated with the audio track is available in the database of video media clips; and
if no video media associated with the audio track is available in the database of video media clips, apply a selection algorithm for the selection of video media.
